(19) United States
(12) Patent Application Publication
(10) Pub. No.: US 2023/0235245 A1
(43) Pub. Date: Jul. 27, 2023

(54) METHOD FOR PROCESSING BLACK LIQUOR SOAP

(71) Applicant: MOLCYCLE OY, Harjamäki (FI)

(72) Inventors: Olavi RAATIKAINEN, Kuopio (FI); Petro SUVANTO, Joensuu (FI); Jouko VEPSÄLÄINEN, Kuopio (FI); Jukka LEPPÄNEN, Kuopio (FI); Petri TURHANEN, Kuopio (FI)

(21) Appl. No.: 18/010,943

(22) PCT Filed: Jun. 24, 2021
(86) PCT No.: PCT/FI2021/050495

§ 371 Date: Dec. 16, 2022

(30) Foreign Application Priority Data
Jun. 26, 2020 (FI) 20205682

(51) Int. Cl. C11B 13/00; C11B 13/02; C11C 3/00

(52) U.S. Cl. CPC C11B 13/005; C11B 13/02; C11C 3/003

(57) ABSTRACT

The invention relates to a method for processing black liquor soap, particularly to a method for producing and recovering fatty acid esters and resin acids from black liquor soap. The method is based on a catalytic selective esterification of the soap.

The present invention relates to a method for processing black liquor soap, especially to a method for producing and recovering fatty acid esters.

### BACKGROUND

Black liquor soap is a by-product of the industrial sulphate cellulose production process. Tall oil soap is a by-product of the industrial sulphate cellulose production process of soft wood. Currently, such soap is processed by sulphuric acid treatment, which converts the ionic forms of resin acids and fatty acids into the acid form producing tall oil.

In the sulphate cellulose production, tall oil soap is a by-product, which is basically completely converted to tall oil by sulphuric acid treatment. However, tall oil soap contains several valuable chemical compounds and fractions which have commercial value. This potential is unused in the current process.

Tall oil soap is produced when fatty acids and resin acids of the wood material are converted into ionic forms in the alkaline conditions. Once the alkaline solution is evaporated, the tall oil soap concentrates on the top of the solution, where it can be collected mechanically. This fraction is then treated with sulphuric acid and the tall oil is formed as a viscose fraction. Tall oil is further distilled to produce fatty acid and resin acid fractions.

WO 2018/065876 A1 discloses a process for separating unsaponifiables from tall oil soap (TOS) using co-distillation. WO 2017/130127 A1 discloses an extraction of phytosterols from alkaline tall oil soap which is obtained from the Kraft process black liquor by skimming.

Turhanen et al. (ACS omega 2019; 4, 8974-8984) discloses esterification reactions using carboxylic acids and alcohols as a starting material using a cation exchange resin catalyst.

One drawback of the prior art processes is a relatively high energy demand and a difficulty in recovering valuable fractions for further processing. There is a constant need for providing more effective and easier means for recovering valuable components derivable from the black liquor soap.

### SUMMARY

The present disclosure generally relates to methods for processing black liquor soap.

The aspect of the invention is a method for producing and recovering fatty acid esters and resin acids. Characteristic steps of said method are depicted in claim 1.

The method provides a catalytic selective esterification and fractionation process for black liquor soap. Compared to prior art processes the method is environmentally friendly and economic.

The present invention provides a method for producing fatty acid esters using an acid catalyst (e.g. mineral acid catalyst, such as H₂SO₄, organic acids, such as trifluoroacetic acid (TFA), or acid form solid catalyst, such as ion exchange resin catalyst) and recovering them from black liquour soap. Especially the present invention provides a method for producing fatty acid esters and separating them from resin acids of tall oil soap with an acid catalyst. The inventors have surprisingly found that dissolving black liquor soap to alcohol enables a direct selective esterification of fatty acids. Alcohol serves as a solvent and as a substrate for the reaction. The acid catalyst enhances the esterification process and improves selectivity towards primary carboxyl acids.

When softwood derived black liquor is treated using traditional acidification process, it causes esterification of fatty acids but also a minor part of resin acids are esterified. Hence, if recovered by extraction with organic solvents esterified resin acids are coextracted with fatty acids. In the later phases additional operations are needed to separate fatty acid esters from resin acid esters. The separation is distillation and needs energy. The present invention overcomes the problem and allows recovering valuable resins acids as an essentially pure fraction.

One advantage of the invention is the use of a selective catalyst in the esterification reaction of the fatty acids within the soap. This is an environmentally friendly and more efficient way than a traditional sulphuric acid treatment. The fatty acid esters and resin acids obtainable by the method here disclosed are environmentally friendly “green label” products when compared to raw oil based products.

An advantage of the present invention is improved energy and cost efficiency in black liquor soap processing. Distillation of high boiling point products, such as fatty acids or resin acids, may be avoided, greatly enhancing the energy efficiency of the process. Furthermore, the separation of fatty acids (as esters) from resin acids is achieved through the selective esterification in a simple, low-cost process. Black liquor soap may be processed with more energy-efficient methods. Using the method of the present invention, the product fractions obtained from the black liquor soap may be separated and purified by simple extraction and precipitation steps, without the need of distillation of the product fractions themselves. Only low boiling point solvents are recycled via evaporation or distillation techniques.

A further advantage of the present invention is the industrial scalability and compatibility of the method with existing industrial processes. No vast modifications of already existing black liquor processing sites are needed. The invention provides pre-extractions and raw compounds that can directly be used in existing processes and processing sites.

A yet further advantage of the present invention is that the method enables recycling of the used solvents. Alcohols and organic solvents used in the method are partly or entirely recyclable through evaporation and distillation methods, making the present invention compatible with the concept of circular economy.

### BRIEF DESCRIPTION OF FIGURES

FIG. 1 shows ¹H NMR spectrum measured from black liquor soap used as a starting material.

FIG. 2 shows ¹H NMR spectrum measured from separated fraction containing mixture of fatty acids methyl esters obtained from resin-catalysed esterification.

FIG. 3 shows ¹H NMR spectrum measured from separated fraction containing mixture of resin acids obtained from resin-catalysed esterification.

FIG. 4 shows ¹H NMR spectrum measured from pure DHAA (>97%) fraction separated by High Performance Counter Current Chromatography (HPCCC) from mixture of resin acids obtained from resin-catalysed esterification.

FIG. 5 shows ¹H NMR spectrum measured from mixture of resin acids obtained from resin-catalysed esterification, in which the DHAA has been separated by HPCCC.

FIG. 6 shows ¹H NMR spectra measured from mixture of resin acids in residual sample and purified resin acids obtained from acid-catalysed esterification.

### DETAILED DESCRIPTION

The present invention provides a method for producing and recovering fatty acid esters from black liquor soap. The method comprises the steps of
a. dissolving black liquor soap to alcohol; and
b. adjusting pH to <8, preferably <7 with acid; and
c. adding either a catalyst or a strong acid to obtain selective esterification; and
d. incubating under mixing to allow at least partial esterification of fatty acids of the soap; and
e. separating the alcohol and recovering the remaining fraction comprising fatty acid esters; and
f. adding alkali to the recovered fraction; and
g. extracting the product with an organic solvent to collect the fatty acid esters to the separated organic solvent; and
h. recovering resin acids from an aqueous phase remaining after step g.

According to the invention, the black liquor soap may be a soap produced within pulping of softwood, preferably the soap is a tall oil soap. Recovering of the resin acids in step h. may be carried out by extraction or precipitation methods or phase separation using chemical additives, for example.

Examples of softwood are Scots pine, European spruce, Eastern white pine, Larch, Douglas fir, Lodgepole pine, Parana pine, Sitka spruce, Southern yellow pine, Western hemlock, Red cedar and Yew.

The alcohol in step a. may be any alcohol able to form esters with fatty acids. It may be cyclic alcohol, aromatic alcohol, sugar containing alcohol, branched alcohol or alcohol with straight chain. Typically alcohols with high molecular weight require more harsh reaction conditions, a stronger, i.e., more effective catalyst, elevated temperature and/or prolonged reaction time. Optimization of these parameters can be done by a person skilled in the art. Common industrial or research grade alcohols are suitable for the present invention. Typically, the weight percentage of the used alcohol may be in the range of 70-100 wt-%, preferably 80-95 wt-% of the total weight of the solvent, the remainder typically being water and/or other impurities.

Examples of suitable alcohols are C₁₋₅ alcohols such as methanol, ethanol, butanol. propanol, isopropanol, preferably methanol or ethanol. In one embodiment the alcohol is methanol. Alcohol as a solvent is also a substrate for the esterification reaction.

Alcohol is added to black liquor soap in excess to allow complete (at least 95 mol-%) esterification. According to the invention, the volume ratio of the alcohol to the black liquor soap may be in the range of 1:2-10:1 (volume of alcohol:volume of black liquor soap), preferably 1:1-8:1, more preferably 2:1-5:1.

The acid at steps b. and/or c. may be any strong acid, which typically have a pKa value less than 4, such as mineral acid, such as nitric acid (HNO₃), hydrochloric acid (HCl), perchloric acid (HClO₄) or sulphuric acid (H₂SO₄), or organic acid, such as trifluoroacetic acid or formic acid. In one embodiment the acid is H₂SO₄ commonly used within pulp & paper industry. Chlorine-containing acids may expedite the corrosion of certain materials. pH adjustment in step b. to neutral or acidic converts fatty acid salts and resin acid salt to their respective acids.

A selective esterification may be accomplished by carefully selecting the pH of the reaction mixture in step c. The selective esterification is obtained by adding either a catalyst or a strong acid in step c.

In embodiments utilizing the acid only, the pH value is ≤0. The pH value may be in the range of −2.5−0, preferably −1−0. At pH values >0, the fatty acid esterification reaction is incomplete, and fatty acids may transfer to the resin acids fraction. At pH values of 0.34 or 0.21, the fatty acid content of the resin acids fraction may be up to 25 mol-% of the resin acids fraction. The inventors have surprisingly found that by selecting the pH value to be 0, the fatty acids may selectively be esterified and a fatty acid content in the resin acids fraction may be less than 10 mol-%, such as 0-10 mol-%, preferably less than 5 mol-%, such as 0-5 mol-% of the resin acids fraction.

In an alternative embodiment, the selective esterification of fatty acids may be obtained by using a catalyst together with the acid. The catalyst may be added to the reaction mixture after the acidifying step b. In embodiments involving a catalyst together with the acid, pH values may be higher than when using acid only. In an embodiment involving a catalyst together with acid, pH value may be <8, preferably <7. The pH value may be in the range of −2-8, preferably 0-7, more preferably 1-5, or even more preferably 1-4. The catalyst may be any catalytic compound causing esterification, usually an acid form solid catalyst, such as an ion exchange resin catalyst, preferably a cation exchange catalyst. Non-limiting examples of commercial catalyst are Dowex 50WX8, Dowex Marathon C, Amberlite, Amberjet IRC, C, Diaion, Indion, Purolite and Purofine. The resin catalyst used in the process is recyclable. The acid form solid catalyst may be recovered for re-use by known methods such as filtration or centrifugation after the incubation in step d.

The esterification reaction of step d. may be further enhanced by adding a dried NaI catalyst in connection of step c.

The incubation at step d. is performed at a temperature below the boiling point of the used alcohol, e.g. at a temperature of 10 to 80° C. Typical incubation times at ambient temperature are 8 to 48 hours and at ambient temperature or temperatures 40, 60 or 80° C. for 2 to 36 hours. Alcohols with longer or more hindered carbon chain length, such as isopropyl alcohol, may require elevated temperatures.

Separation of the alcohol in step e. may be done by evaporation in vacuo or e.g. using distillation methods including short path distillation to recycle most of the alcohol. In step e. the evaporation of alcohol may be done to dryness.

The alkali added in step f. may be any earth alkali hydroxide, such as KOH or NaOH, preferably NaOH. It is added until pH is at least 7, such as at least 8, 9, 10, 11 or 12. Typically pH is at least 10. The pH value may be in the range of 7-14, such as 8-14, 9-14, 10-14, 11-14, or 12-14. Typically the pH value is in the range of 10-14. The alkali is typically added as a solution having a concentration of 1-10 M. The aim is to make the solution basic so that resin acids are totally water soluble (in salt form) and not extractable to an organic solvent. Thus, resin acid salts can then be recovered from the aqueous phase.

Water may be added into the recovered fraction with the alkali in step f. The volume of water added may be approximately the same as the volume of black liquor soap originally used. Typically, the volume ratio of the water added in step f. to the volume of black liquor soap originally used may be in the range of 1:2-2:1, preferably 2:3-3:2.

The fatty acid esters are recovered in step g. The recovery is carried out by extracting the product obtained in step f. with an organic solvent to collect the fatty acid esters to the separated organic solvent.

The organic solvent in step g. may be any water insoluble organic solvent capable to extract the produced fatty acid esters or resin acids from the water phase, such as ethyl acetate, dichloromethane (DCM), hexane, pentane, heptane, cyclohexane, toluene, chloroform, preferably ethyl acetate being easily recycled within the process, non-toxic, environmentally friendly and easy to use. The organic solvent used in the process is recyclable.

The basic mixture obtained in step f. is typically extracted 2 times in step g.

The volume ratio of the organic solvent to the volume of the black liquor soap originally used may be in the range of 1:2-4:1, preferably 2:3-3:1, more preferably 1:1-2:1.

The fatty acid esters are separated from the organic solvent by evaporating the organic solvent. Evaporation of the organic solvent may be done by evaporation in vacuo or e.g. using distillation methods, such as short path distillation to recycle most of the organic solvent. The evaporation of the organic solvent may be done to dryness.

The fatty acid esters remain after the solvent evaporation in step g. as a thick liquid.

The resin acids are recovered in step h. from an aqueous phase remaining after step g. The resin acids recovery may be carried out by e.g. extraction or phase separation methods.

In an embodiment, the resin acids may be recovered by extraction using the following further steps
h1. acidifying the remaining aqueous phase with mineral acid; and
h2. extracting with organic solvent; and
h3. evaporating said organic solvent to recover a resin acids fraction to provide the resin acids fraction.

The resin acids extraction may alternatively comprise the following further steps
h1. acidifying the remaining aqueous phase with mineral acid; and
h2. extracting with organic solvent; and
h3. adding alkali until phase separation is completed; and
h4. separating the resin acid fraction for further purification.

The organic solvent in step h2. may be any water insoluble organic solvent capable to extract the produced fatty acid esters or resin acids from the water phase, such as ethyl acetate, dichloromethane (DCM), hexane, pentane, heptane, cyclohexane, toluene, chloroform, preferably ethyl acetate being easily recycled within the process, non-toxic, environmentally friendly and easy to use. The organic solvent used in the process is recyclable.

Evaporation of the organic solvent may be done by evaporation in vacuo or e.g. using distillation methods, such as short path distillation to recycle most of the organic solvent. The resin acids may then be easily collected and possibly further purified.

The alkali may be added in step h. to enhance the phase separation of the resin acids from the organic solvent. The alkali added in step h. may be any earth alkali hydroxide, such as KOH or NaOH, preferably NaOH. It is added until pH is at least 7, such as at least 8, 9, 10, 11 or 12. Typically pH is at least 10. The pH value may be in the range of 7-14, such as 8-14, 9-14, 10-14, 11-14, or 12-14. Typically the pH value is in the range of 10-14. The alkali is typically added as a solution having a concentration of 1-10 M. Salts of organic acids, such as the resin acids, are not soluble in organic solvents. The resin acids convert to their respective salts upon the alkali addition, and thus become insoluble in the organic solvent. Thus, the phase separation is enhanced, and the resin acids may be easily collected for further purification. In this embodiment, the organic solvent may be collected after the phase separation and recycled for further use.

In an alternative embodiment, the resin acids may be recovered by separation using the following further steps
h1. acidifying the remaining aqueous phase with acid, providing deionized resin acids as a phase on top of the aqueous fraction; and
h2. collecting the resin acid fraction.

The resin acids may easily be collected from the surface of the aqueous fraction. This is due to the fact that resin acids are insoluble to water in their acid form.

Acidification under step h1. in both extraction and phase separation methods converts resin acid salts to respective acids. In the extraction methods, mineral acids remain in the aqueous phase and thereby enhance recovery and reuse of the organic phase. The acidification may be carried out using mineral acids, such as HCl, H₂SO₄, or trifluoroacetic acid, or mixtures thereof, preferably H₂SO₄. The pH value is typically adjusted to <7, preferably <4, such as in the range of −2-7, 0-5, or 1-4 in order to efficiently convert the resin acid salts to the deionized form.

The resin acids may be further separated and purified by industrial-scale chromatographic methods, such as liquid-liquid extraction chromatography, preferably high-performance counter current chromatography (HPCCC) or centrifugal partition chromatography (CPC). Compared to the conventional resin acid purification methods by distillation, the method presented herein is more efficient in terms of cost and energy demand. The method presented herein is also faster than conventional processes.

In an embodiment, stanols and/or sterols may be separated and recovered from the black liquor soap. Stanols and/or sterols contained in the black liquor soap may precipitate during the esterification process in step d. The precipitate comprising stanols and/or sterols, such as sitostanol and sitosterol, may be separated from the product obtained in step d of the method.

Stanols and/or sterols may be recovered by methods known in the art, such as filtering from the product obtained in step d.

The stanols and/or sterols obtained from the black liquor soap may be further separated and purified by flash-chromatography (FLASH) using solvents and solid phases known in the art. In addition, liquid-liquid extraction chromatography techniques such as high performance counter current chromatography (HPCCC) or centrifugal partition chromatography (CPC) may be used. Also high performance liquid chromatography (HPLC) can be applied in further purification of stanols and sterols.

An advantage of this embodiment is that stanols and sterols may be separated as a profitable by-product by simple and cost-efficient process steps. The resulting stanols and/or sterols may be used, e.g., as dietary supplements due to their cholesterol-lowering effects. Plant stanols and/or sterols are known to block cholesterol absorption sites in the human intestine, thus helping to reduce cholesterol absorption in humans.

The invention is illustrated below by the following non-limiting examples. It should be understood that the embodiments given in the description above and the examples are for illustrative purposes only, and that various changes and modifications are possible within the scope of the invention.

### EXAMPLES

### Example 1

### Resin-Catalysed Esterification and Resin Acids Separation by Extraction

Process description in laboratory scale, an example: Tall oil soap (ca. 9 g) obtained from typical Nordic Kraft process for soft wood was dissolved in MeOH (20 ml) and pH adjusted with conc. H₂SO₄ to <4; dried NaI (catalyte B) (400 mg) and dried Dowex 50WX8 ion-exchange resin (catalyte A) (1 g) were added and the mixture were stirred at room temperature for 18 h before catalyte A was collected after filtration and washed with small portion of MeOH and the reaction mixture evaporated to dryness in vacuo.

The remaining fraction was made basic with 1M NaOH and washed three times with EtOAc (3×10 ml) to collect fatty acid methyl esters.

The remaining water phase was acidified with 3M HCl and extracted three times with EtOAc (3×10 ml). The organic fractions were evaporated in vacuo to give resin acids fraction for further use.

### Example 2

### Selective Acid-Catalysed Esterification and Resin Acids Separation by Extraction

Tall oil soap (ca. 55 g) obtained from typical Nordic Kraft process for soft wood was dissolved in MeOH (200 ml) and pH adjusted with conc. H₂SO₄ to <0. The mixture was allowed to react at room temperature for 18 h under stirring.

MeOH was evaporated and ca. 100 ml water was added to the residue.

The residue was made basic (pH>11) with 1M NaOH (ca. 80 ml) and extracted twice with EtOAc (2×150 ml). The organic fractions were combined and EtOAc was evaporated, leaving a fraction comprising fatty acid methyl esters (ca. 30 g).

The remaining water phase, containing resin acids, was acidified with either 2M HCl or 1M H₂SO₄ and extracted with EtOAc (ca. 100 ml). The organic fraction was evaporated to give resin acids fraction for further use (ca. 15 g).

### Example 3

### Acid-Catalysed Esterification and Resin Acid Phase Separation Using Chemical Additives

EtOAc fraction (1500 ml) obtained from 500 g of black liquor soap after similar process as described in the Example 3 was made alkaline with a suitable base, e.g. NaOH or KOH or Mg(OH)₂ until phase separation is completed. Typically 99 mol-% separation is achieved as indicated by NMR spectra of separated phases.

Ethyl acetate fraction was alkalinized by adding suitable amount of 1M NaOH until phase separation or precipitation.

### Example 4

### NMR Analysis of Recovered Fractions

Fractions recovered from process described in Example 1 were analyzed using NMR. The results are the following:

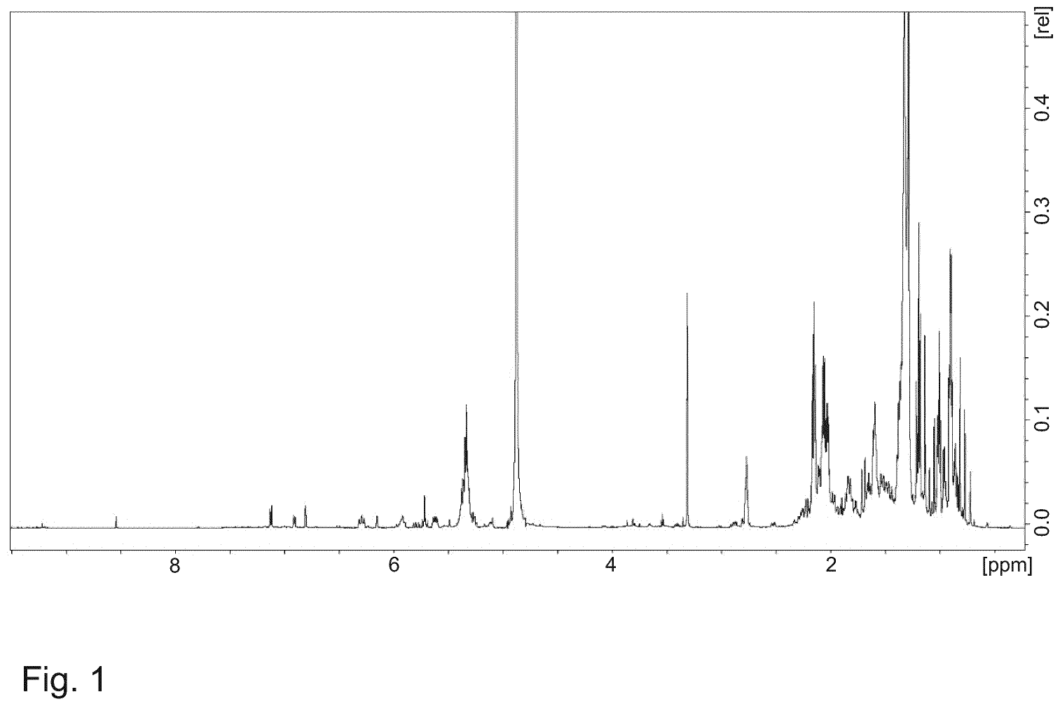

In FIG. 1, one can see the ¹H NMR spectrum measured from the starting material. The spectrum contain typical signals for tall oil soap: aromatic and double bond chemical shifts with characteristic —CH2— and —CH3 chemical shifts for resin and fatty acids.

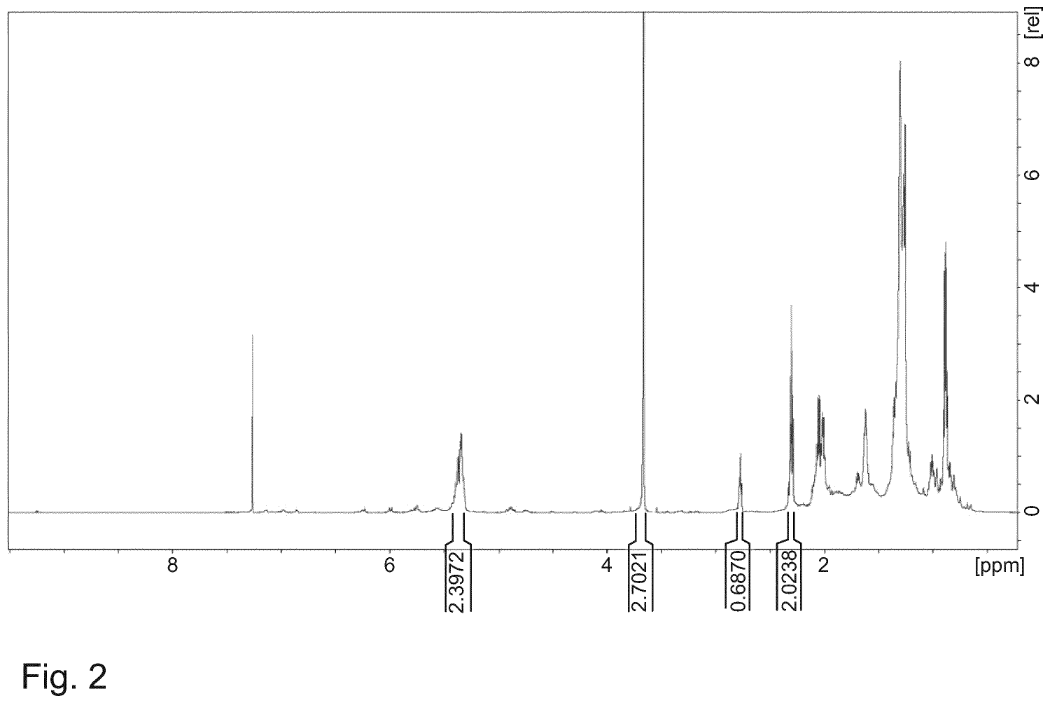

In FIG. 2, one can see the ¹H NMR spectrum measured from the fatty acid ester fraction. The spectrum shows clearly typical fatty acid double bond signals at (CH═CH) 5.5-5.3 ppm and also methyl ester signal −at 3.66 ppm. According to CH3 groups integrals the esterification of fatty acids is completed and no resin acids exist in this spectrum.

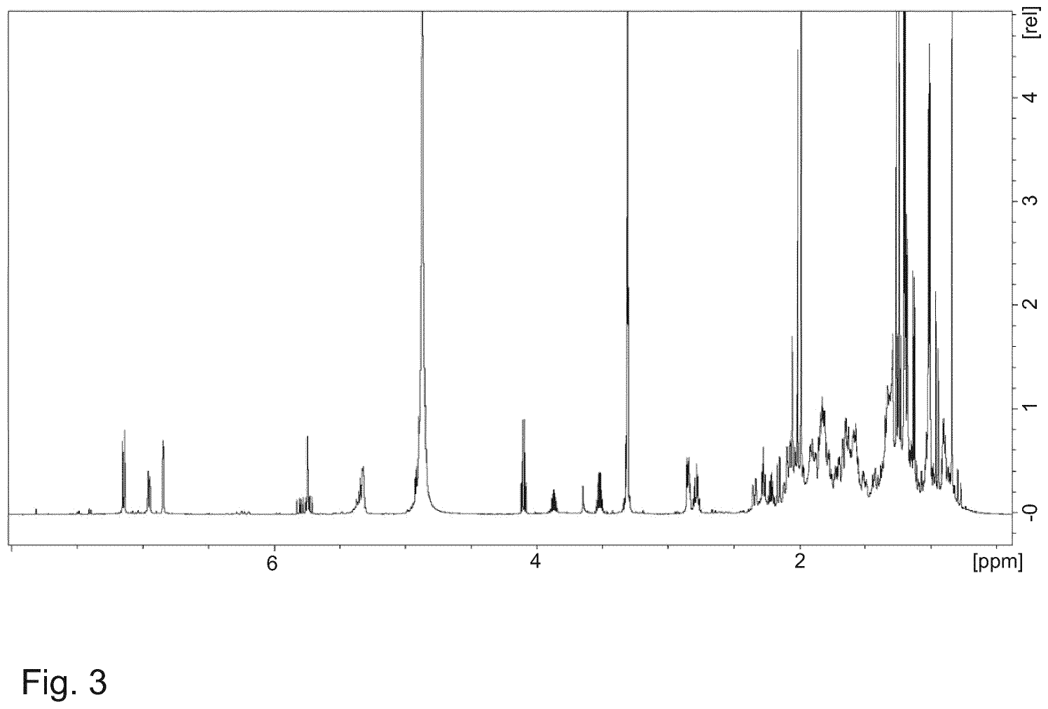

In FIG. 3, one can see the ¹H NMR spectrum of a typical mixture of resin acids including e.g. abietic and pimaric acid derivatives.

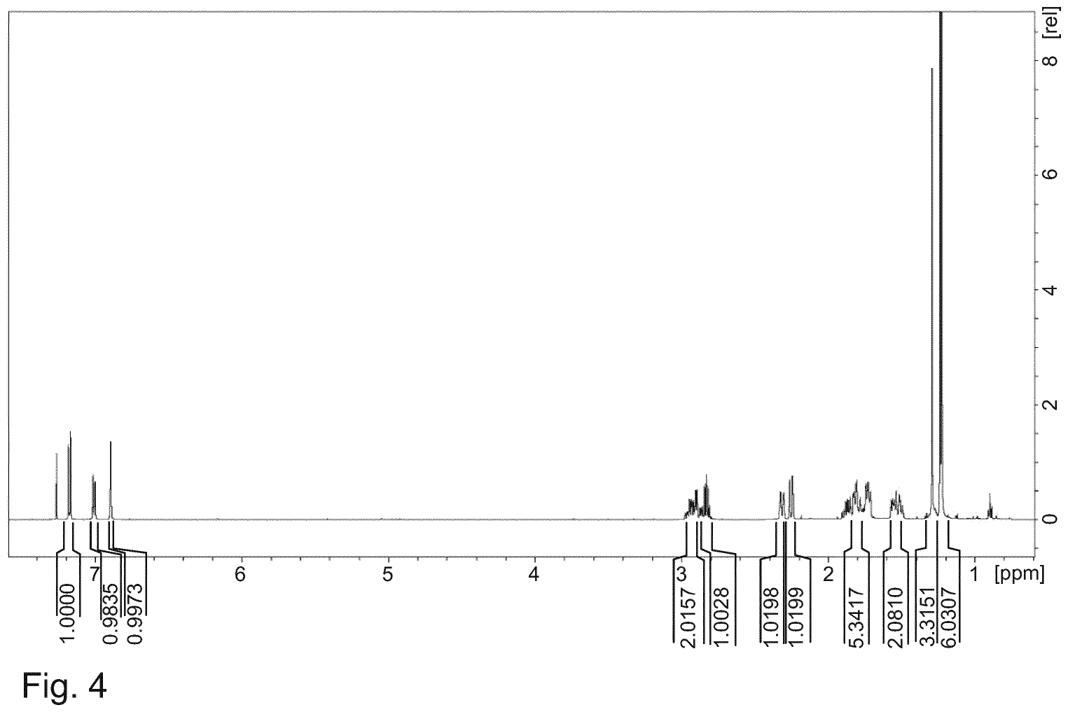

In FIG. 4, one can see the ¹H NMR spectrum measured from pure dehydroabietic acid (>97%) separated by HPCCC from mixture of resin acids.

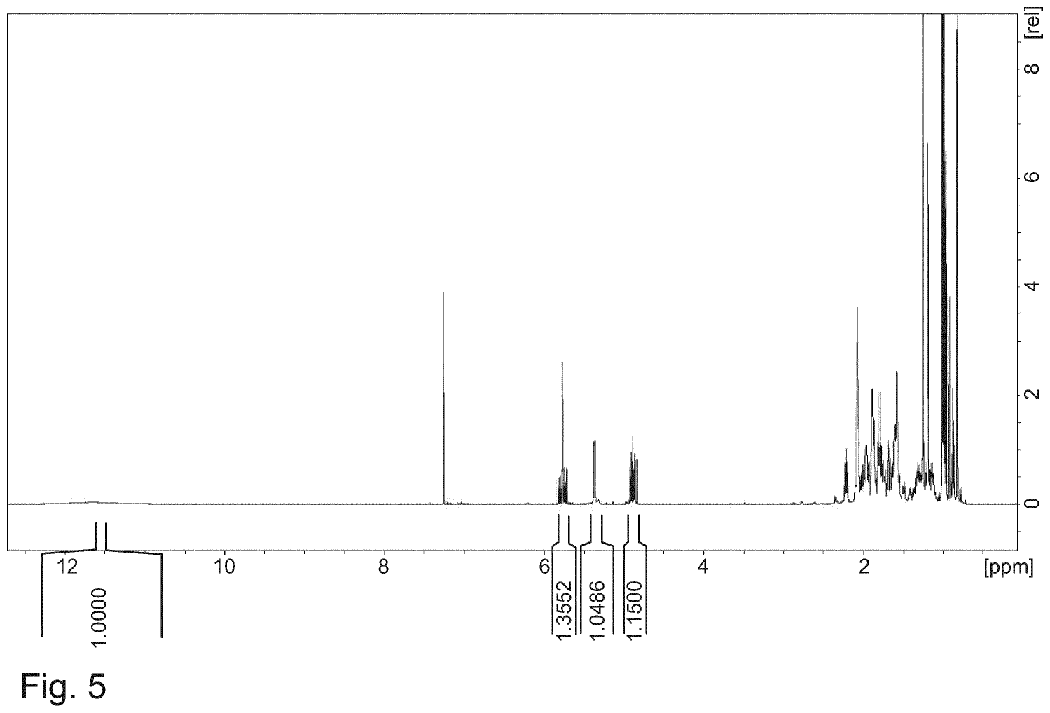

In FIG. 5, one can see the ¹H NMR spectrum of resin acids measured in CDCl₃. The spectrum shows also characteristic broad acid proton signals for resin acids.

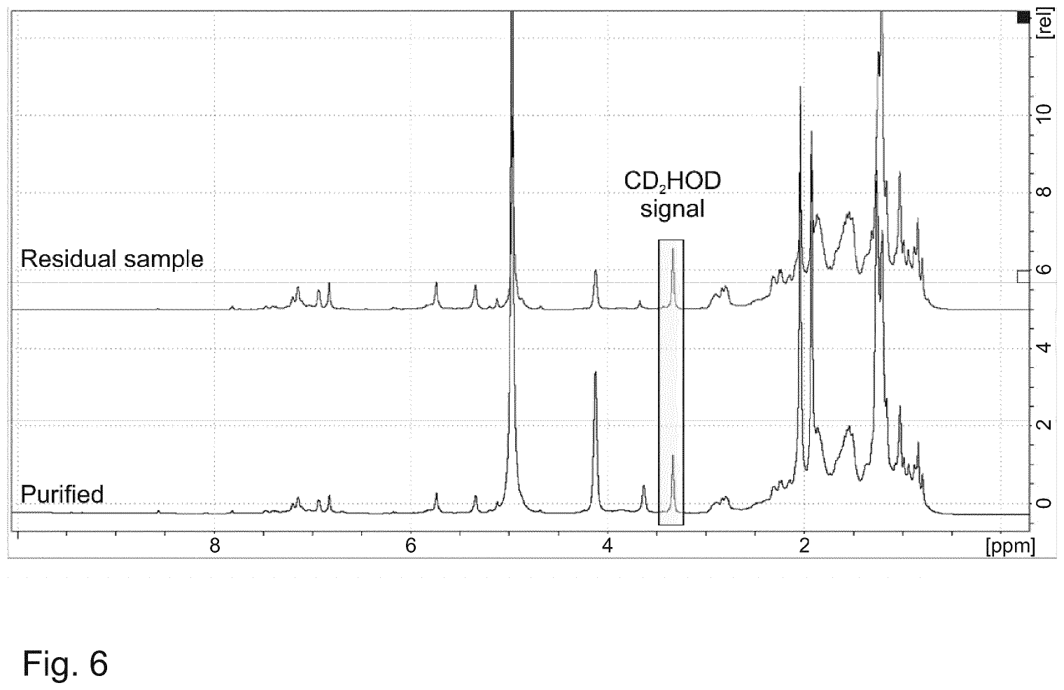

In FIG. 6 one can see the ¹H NMR spectra measured from mixture of resin acids in residual sample (top) and purified resin acids (bottom) obtained from acid-catalysed esterification. The spectra are essentially similar, indicating that the residual sample is similar in purity compared to the purified sample. In other words, the resin acids are obtained as a fraction with high (99 mol-%) purity, allowing recycling of the used organic solvent.

1. A method for producing and recovering fatty acid esters and resin acids from a soap produced within pulping of softwood, comprising the steps of:
a. dissolving black liquor soap to alcohol;
b. adjusting pH to <8 with acid;
c. adding either a catalyst or a strong acid to obtain selective esterification;
d. incubating under mixing to selectively esterify at least part of fatty acids;
e. separating the alcohol and recovering a remaining fraction comprising fatty acid esters;
f. adding alkali to the recovered fraction;
g. extracting a product with an organic solvent to collect the fatty acid esters to the separated organic solvent; and
h. recovering resin acids from an aqueous phase remaining after step g.

2. The method of claim 1, wherein said soap is a tall oil soap.

3. The method of claim 1, wherein the acid in steps b. and/or c. is any mineral acid, or organic acid.

4. The method of claim 1, wherein pH is adjusted to ≤0 in step c by adding the strong acid.

5. The method of claim 1, further comprising adding an acid form solid catalyst in connection of step c.

6. The method of claim 5, further comprising recovering the acid form solid catalyst after incubation.

7. The method of claim 1, further comprising adding NaI catalyst in connection of step c.

8. The method of claim 1, wherein the incubation at step d. is performed at temperature 20 to 80° C. for 2 to 48 hours.

9. The method of claim 1, wherein in step e. alcohol is separated by evaporation in vacuo.

10. The method of claim 1, wherein the alcohol is methanol or ethanol.

11. The method of claim 1, wherein the organic solvent is ethyl acetate.

12. The method of claim 1, wherein recovering of the resin acids in step h. comprises the following further steps:
h1. acidifying the remaining aqueous phase with a mineral acid;
h2. extracting with organic solvent;
h3. evaporating said organic solvent to recover a resin acids fraction to provide the resin acids fraction.

13. The method of claim 1, wherein recovering of the resin acids in step h. comprises following further steps:
h1. acidifying the remaining aqueous phase with mineral acid; and
h2. extracting with organic solvent;
h3. adding alkali until phase separation is completed;
h4. separating the resin acid fraction for further purification.

14. The method of claim 1, wherein recovering of the resin acids in step h. comprises the following further steps
h1. acidifying the remaining aqueous phase with an acid, providing deionized resin acids as a phase on top of the aqueous fraction; and
h2. collecting the resin acid fraction.

15. The method of claim 1, further comprising precipitation of stanols and/or sterols during esterification process in step d, and separating the precipitate comprising stanols and/or sterols from the product obtained in step d.

16. The method of claim 1, wherein in step b. the pH is adjusted to <7.

17. The method of claim 3, wherein the mineral acid is selected from the group consisting of nitric acid (HNO₃), hydrochloric acid (HCl), perchloric acid (HClO₄) and sulphuric acid (H₂SO₄) and the organic acid is selected from the group consisting of trifluoroacectic acid, and formic acid.
